(19) United States
(12) Patent Application Publication
(10) Pub. No.: US 2021/0249019 A1
(43) Pub. Date: Aug. 12, 2021

(54) SPEECH RECOGNITION METHOD, SYSTEM AND STORAGE MEDIUM

(71) Applicant: SHENZHEN ZHUIYI TECHNOLOGY CO., LTD., Shenzhen, Guangdong (CN)

(72) Inventors: Feng LIU, Shenzhen (CN); Yunfeng LIU, Shenzhen (CN); Yue WU, Shenzhen (CN); Xiao HU, Shenzhen (CN); Linding WEN, Shenzhen (CN)

(21) Appl. No.: 17/270,769

(22) PCT Filed: Aug. 13, 2019
(86) PCT No.: PCT/CN2019/100297

§ 371 Date: Feb. 23, 2021

(30) Foreign Application Priority Data
Aug. 29, 2018 (CN) 201810999134.7

(51) Int. Cl. G10L 15/34; G10L 15/18; G10L 15/02

(52) U.S. Cl. CPC G10L 15/34; G10L 15/02; G10L 15/18

(57) ABSTRACT

Provided are a speech recognition method and system, and a storage medium. The speech recognition method includes: receiving a feature vector and a decoding map sent by a CPU, wherein the feature vector is extracted from a speech signal, and the decoding map is pre-trained; recognizing the feature vector according to a pre-trained acoustic model to obtain a probability matrix; decoding the probability matrix according to the decoding map using a parallel mechanism to obtain text sequence information; and sending the text sequence information to the CPU.

### CROSS REFERENCE TO RELATED APPLICATIONS

This application is a National Phase of International Patent Application PCT/CN2019/100297, filed on Aug. 13, 2019, which claims priority to Chinese Patent Application No. 201810999134.7, filed on Aug. 29, 2018, entitled “SPEECH RECOGNITION METHOD AND RELATED APPARATUS”, the content of which is hereby incorporated by reference in their entireties.

### TECHNICAL FIELD

The present disclosure relates to a speech recognition method and system, and a storage medium.

### BACKGROUND

The speech recognition technology, as an important technology for the speech communication in human-machine interaction, has been widely concerned by the scientific community in various countries. The products developed by the speech recognition technology have been widely applied in various fields, and almost used in every industry and every aspect of the society, thus, the prospect of the application, and economy-social benefit is considerable. Therefore, the speech recognition technology is not only an important technology for international competition, but also an indispensable technical support for the economic development of every country. In terms of the social meaning and economic meaning, it is significant for studying the speech recognition and developing corresponding products.

For the speech recognition, a speech signal can be extracted, recognized, decoded to acquire a text sequence. The decoding process is a process of continuously traversing and searching in a decoding map. The CPU needs to traverse the edges of each active vertex in the decoding map, which results in an intensive calculation amount for decoding. However, the operation mechanism of the CPU is generally a single-thread mechanism, in which, the programs to be executed are arranged in series during the execution, that is, a previous program must be processed, and then a later program shall be executed.

### SUMMARY

According to various embodiments of the present disclosure, a speech recognition method and system, and a storage medium are provided.

According to a first aspect of the present disclosure, a speech recognition method is provided, which includes: receiving a feature vector and a decoding map sent by a central processing unit (CPU), wherein the feature vector is extracted from a speech signal, and the decoding map is pre-trained; recognizing the feature vector according to a pre-trained acoustic model to obtain a probability matrix; decoding the probability matrix according to the decoding map using a parallel mechanism to obtain text sequence information; and sending the text sequence information to the CPU.

According to a second aspect of the present disclosure, a speech recognition method is provided, which includes: extracting a feature vector from a speech signal; acquiring a decoding map which is pre-trained; sending the feature vector and the decoding map to a graphics processing unit (GPU), to enable the GPU to recognize the feature vector according to a pre-trained acoustic model to obtain a probability matrix and decode the probability matrix according to the decoding map using a parallel mechanism to obtain text sequence information; and receiving the text sequence information sent by the GPU.

According to a third aspect of the present disclosure, a speech recognition system is provided, which includes: a CPU and a GPU connected with the CPU.

The CPU is configured to execute following operations for the speech recognition method: extracting a feature vector from a speech signal; acquiring a decoding map which is pre-trained; sending the feature vector and the decoding map to the GPU; and receiving text sequence information sent by the GPU.

The GPU is configured to execute following operations for the speech recognition method: receiving the feature vector and the decoding map sent by the CPU; recognizing the feature vector according to a pre-trained acoustic model to obtain a probability matrix; decoding the probability matrix according to the decoding map using a parallel mechanism to obtain the text sequence information; and sending the text sequence information to the CPU.

According to a fourth aspect of the present disclosure, a storage medium is provided, which stores a first computer program and a second computer program.

when the first computer program is executed by a GPU, following operations for the speech recognition method are implemented: receiving a feature vector and a decoding map sent by a CPU; recognizing the feature vector according to a pre-trained acoustic model to obtain a probability matrix; decoding the probability matrix according to the decoding map using a parallel mechanism to obtain text sequence information; and sending the text sequence information to the CPU; and

when the second computer program for the speech recognition method is executed by the CPU, following operations are implemented: extracting the feature vector from a speech signal; acquiring the decoding map which is pre-trained; sending the feature vector and the decoding map to the GPU; and receiving text sequence information sent by the GPU.

Details of one or more embodiments of the present disclosure are presented in the following drawings and specification. Other features, objects and advantages of the invention will become apparent from the description, the accompanying drawings and claims.

It should be understood that the above general description and the following detailed description are illustrative and explanatory only and do not limit to the present disclosure.

### BRIEF DESCRIPTION OF THE DRAWINGS

To illustrate the technical solutions according to the embodiments of the present disclosure or in the related art more clearly, the accompanying drawings for describing the embodiments or the prior art are introduced briefly in the following. Apparently, the accompanying drawings in the following description are only some embodiments of the present disclosure, and persons of ordinary skill in the art can derive other drawings from the accompanying drawings without creative efforts.

FIG. 1 is view of an application environment for a speech recognition method according to an embodiment of the present disclosure.

FIG. 2 is a schematic flowchart of a speech recognition method according to a first embodiment of the present disclosure.

FIG. 3 is a schematic flowchart of a decoding method according to the first embodiment of the present disclosure.

FIG. 4 is a schematic flowchart of a method for acquiring an active label object according to the first embodiment of the present disclosure.

FIG. 5 is a schematic flowchart of a speech recognition method according to a second embodiment of the present disclosure.

FIG. 6 is a schematic structural view of a speech recognition apparatus according to a third embodiment of the present disclosure.

FIG. 7 is a schematic structural view of a decoding module according to the third embodiment of the present disclosure.

FIG. 8 is a schematic structural view of a second acquisition unit according to the third embodiment of the present disclosure.

FIG. 9 is a schematic structural view of a speech recognition apparatus according to a fourth embodiment of the present disclosure.

FIG. 10 is a schematic structural view of a speech recognition system according to a fifth embodiment of the present disclosure.

FIG. 11 is a schematic flowchart of a speech recognition method according to a seventh embodiment of the present disclosure.

### DETAILED DESCRIPTION OF THE EMBODIMENTS

In the Background, since the CPU executes such program for decoding with intensive calculation amount, the decoding speed is slow and the user experience is unfavorable.

The present disclosure will now be described in detail with reference to the accompanying drawings and embodiments in order to make the objects, technical solutions, and advantages of the present disclosure clearer. It will be apparent that the described embodiments are merely a portion of but not all of the embodiments of the present disclosure. On the basis of these embodiments of the present disclosure, all other embodiments acquired by those skilled in the art without creative effort shall fall within the scope of the present disclosure.

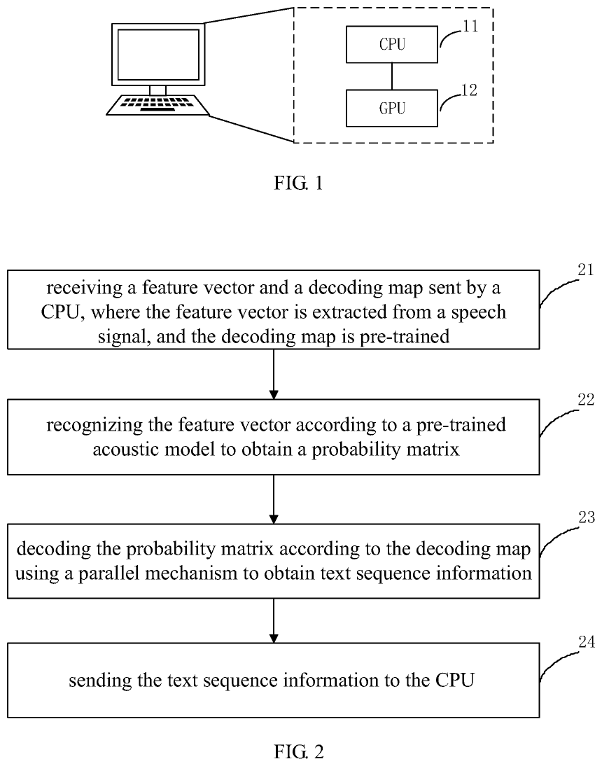

A speech recognition method provided in an embodiment of the present disclosure can be applied to an application environment shown in FIG. 1. A computer device includes a central processing unit (CPU) 11 and a graphics processing unit (GPU) 12 with which are connected. The CPU 11 extracts a feature vector from a speech signal, and acquires a decoding map. The decoding map is pre-trained. The CPU 11 sends the feature vector and the decoding map to the GPU 12. The GPU 12 receives the feature vector and the decoding map sent by the CPU 11, recognizes the feature vector according to a pre-trained acoustic mode to obtain a probability matrix. The GPU 12 decodes the probability matrix according to the decoding map using a parallel mechanism to obtain text sequence information, and sends the text sequence information to the CPU 11. The computer device can be, but is not limited to, a personal computer, a laptop, a smartphone, a tablet, a portable and wearable device, an independent server, or a server cluster composed of a plurality of servers.

FIG. 2 is schematic flowchart of a speech recognition method provided in a first embodiment of the present disclosure.

In this embodiment, the method will be described from a GPU side. As shown in FIG. 2, the method of this embodiment includes following operations.

Operation 21: receiving a feature vector and a decoding map sent by a CPU. The feature vector is extracted from a speech signal, and the decoding map is pre-trained.

Operation 22: recognizing the feature vector according to a pre-trained acoustic model to obtain a probability matrix.

Operation 23: decoding the probability matrix according to the decoding map using a parallel mechanism to obtain text sequence information.

Operation 24: sending the text sequence information to the CPU.

The GPU can receive the feature vector and the decoding map sent by the CPU, then recognize the feature vector according to the pre-trained acoustic model to obtain the probability matrix, and decode the probability matrix according to the decoding map using the parallel mechanism to obtain the text sequence information, and send the text sequence information to the CPU, where the feature vector is extracted from the speech signal by the CPU, and the decoding map is pre-trained. Based on this, the entire decoding process is completed by the GPU using the parallel mechanism. Compared with the related art in which the CPU uses a single-thread mechanism for decoding, the decoding speed of the technical solution in the present disclosure is faster, and the user experience is improved.

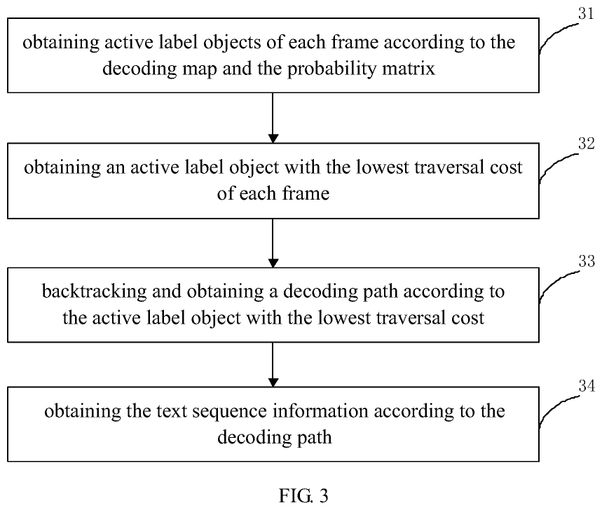

As shown in FIG. 3, in the operation 23, the specific decoding process can include following operations.

Operation 31: obtaining active label objects of each frame according to the decoding map and the probability matrix. The active label object is referred to the active token known in the related art.

Operation 32: obtaining an active label object with the lowest traversal cost of each frame.

Operation 33: backtracking and obtaining a decoding path according to the active label object with the lowest traversal cost.

Operation 34: obtaining the text sequence information according to the decoding path.

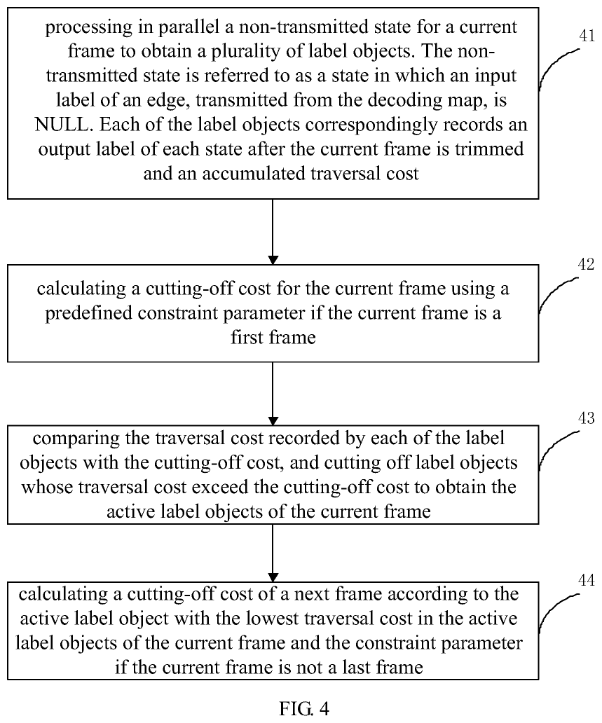

Further, as shown in FIG. 4, in the operation 32, the obtaining the active label object with the lowest traversal cost of each frame can include following operations.

Operation 41: processing in parallel a non-transmitted state for a current frame to obtain a plurality of label objects. The non-transmitted state is referred to as a state in which an input label of an edge, transmitted from the decoding map, is NULL. Each of the label objects correspondingly records an output label of each state after the current frame is trimmed and an accumulated traversal cost. Typically, the edge can include two labels, that is, an input label and an output label. The input label can be a phoneme, and for example, can be an initial consonant or a simple or compound vowel in the Chinese language. The output label can be a recognized Chinese character. In the present disclosure, the state in which the input label of the edge, transmitted from the decoding map, is NULL is referred to as the non-transmitted state, and the state in which the input label of the edge, transmitted from the decoding map, is not NULL is referred to as a transmitted state. The meaning of trimming can be referred to the related art, and details thereof are not repeatedly described herein.

Operation 42: calculating a cutting-off cost for the current frame using a predefined constraint parameter if the current frame is a first frame. The constraint parameter is a Beam commonly used in the related art.

Operation 43: comparing the traversal cost recorded by each of the label objects with the cutting-off cost, and cutting off label objects whose traversal cost exceed the cutting-off cost to obtain the active label objects of the current frame. For each label object, i.e., a token, if its traversal cost exceeds the cutting-off cost, this label object may be considered as a label object with excessive high cost and cannot to be backtracked using a prefect path, therefore, in this operation, it is cut off and the remaining label objects are considered as the active label objects, i.e., the active token.

Operation 44: calculating a cutting-off cost of a next frame according to the active label object with the lowest traversal cost in the active label objects of the current frame and the constraint parameter if the current frame is not a last frame. The cutting-off cost of the first frame is calculated from the operation 42, and the cutting-off costs of other frames can be calculated from the active label object with the lowest traversal cost in the previous frame and the constraint parameter. The method of calculating the cutting-off cost can be calculated by the loss function, and the specific calculation process thereof can be referred to the related art.

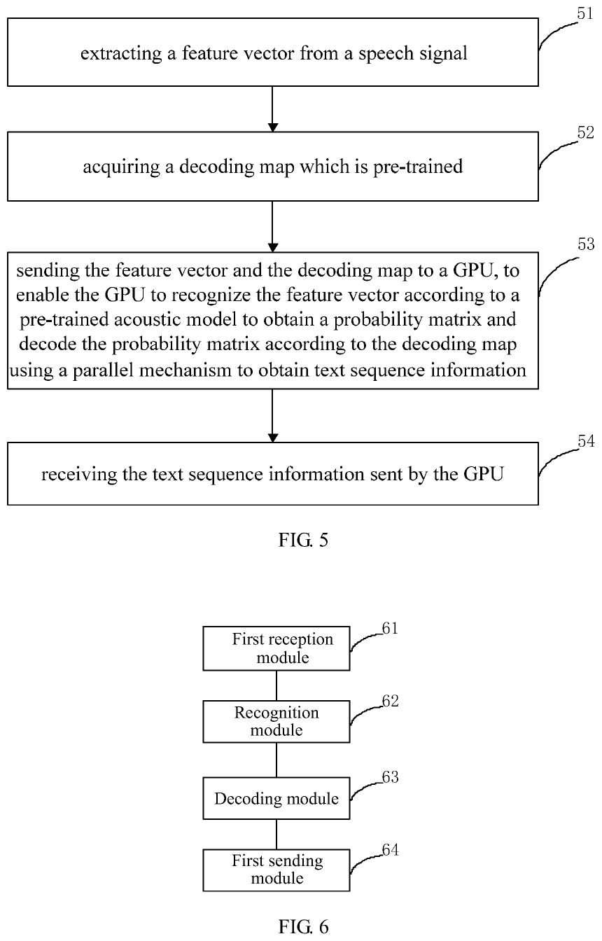

FIG. 5 is a schematic flowchart of a speech recognition method provided in a second embodiment of the present disclosure.

In this embodiment, the method will be described from a CPU side. As shown in FIG. 5, the method of this embodiment includes following operations.

Operation 51: extracting a feature vector from a speech signal.

Operation 52: acquiring a decoding map. The decoding map is pre-trained.

Operation 53: sending the feature vector and the decoding map to a GPU, to enable the GPU to recognize the feature vector according to a pre-trained acoustic model to obtain a probability matrix and decode the probability matrix according to the decoding map using a parallel mechanism to obtain text sequence information.

Operation 54: receiving the text sequence information sent by the GPU.

FIG. 6 is a schematic structural view of a speech recognition apparatus provided in a third embodiment of the present disclosure.

In this embodiment, as shown in FIG. 6, the apparatus can include following modules.

A first reception module 61 is configured to receive a feature vector and a decoding map sent by a CPU. The feature vector is extracted from a speech signal, and the decoding map is pre-trained.

A recognition module 62 is configured to recognize the feature vector according to a pre-trained acoustic model to obtain a probability matrix.

A decoding module 63 is configured to decode the probability matrix according to the decoding map using a parallel mechanism to obtain text sequence information.

A first sending module 64 is configured to send the text sequence information to the CPU.

As shown in FIG. 7, the decoding module can include following modules.

A first acquisition unit 71 is configured to obtain active label objects of each frame according to the decoding map and the probability matrix.

A second acquisition unit 72 is configured to obtain an active label object with the lowest traversal cost of each frame.

A third acquisition unit 73 is configured to backtrack and obtain a decoding path according to the active label object with the lowest traversal cost.

A fourth acquisition unit 74 is configured to obtain the text sequence information according to the decoding path.

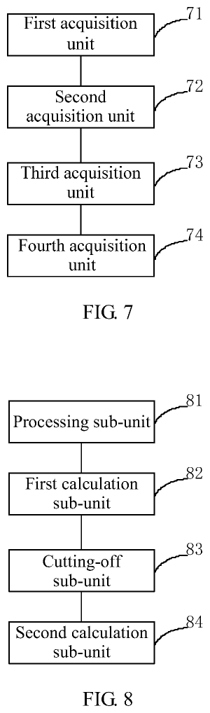

Further, as shown in FIG. 8, the first acquisition unit can include following modules.

A processing sub-unit 81 is configured to process in parallel a non-transmitted state for a current frame to obtain a plurality of label objects. The non-transmitted state is referred to as a state in which an input label of an edge, transmitted from the decoding map, is NULL. Each of the label objects correspondingly records an output label of each state after the current frame is trimmed and an accumulated traversal cost.

A first calculation sub-unit 82 is configured to calculate a cutting-off cost for the current frame using a predefined constraint parameter if the current frame is a first frame.

A cutting-off sub-unit 83 is configured to compare the traversal cost recorded by each of the label objects with the cutting-off cost, and to cut off label objects whose traversal cost exceed the cutting-off cost to obtain the active label objects of the current frame.

A second calculation sub-unit 84 is configured to calculate a cutting-off cost of a next frame according to the active label object with the lowest traversal cost in the active label objects of the current frame and the constraint parameter if the current frame is not a last frame.

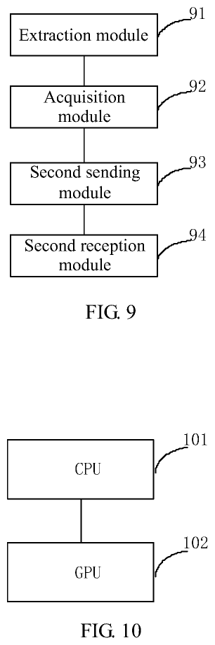

FIG. 9 is a schematic structural view of a speech recognition apparatus provided in a fourth embodiment of the present disclosure.

In this embodiment, as shown in FIG. 9, the apparatus can include following modules.

An extraction module 91 is configured to extract a feature vector from a speech signal.

An acquisition module 92 is configured to acquire a decoding map. The decoding map is pre-trained.

A second sending module 93 is configured to the feature vector and the decoding map to a GPU, to enable the GPU to recognize the feature vector according to a pre-trained acoustic model to obtain a probability matrix and decode the probability matrix according to the decoding map using a parallel mechanism to obtain text sequence information

A second reception module 94 is configured to receive the text sequence information sent by the GPU.

In an embodiment, a speech recognition system is provided, which includes a computer device. The computer device includes a CPU, a GPU, a storage, a network interface, a display screen, and an input component, which are connected via a system bus. The CPU and the GPU the computer apparatus is configured to provide calculation and control capabilities. The storage of the computer device includes a non-volatile storage medium and a memory. The non-volatile storage medium stores an operating system and a computer program. The memory provides an environment for the operation of the operating system and the computer program in the non-volatile storage medium. The network interface of the computer device is configured to communicate with an external terminal via a network connection. The computer program is executed by a processor to implement the speech recognition method. The display screen of the computer device can be a liquid crystal display screen or an electronic ink display screen. The input component of the computer device can be a touch screen covered on the display screen, a button provided on a housing of the computer device, a trackball, a touchpad, an external keyboard, a keypad, a mouse or the like.

Those skilled in the art should appreciate that the structure of a computer device is merely a block view of a portion of the structure related to the solutions of the present disclosure, and does not intend to limit to the computer device to which the solutions of the present disclosure apply. Specifically, the computer device can include more or less components than shown in the drawings, or combine certain components, or have different component arrangements.

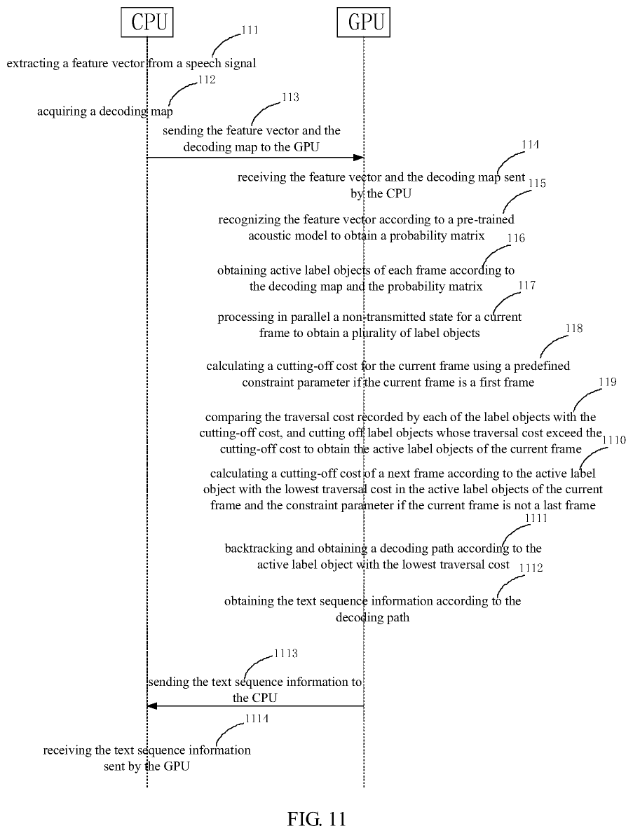

FIG. 10 is a schematic structural view of a speech recognition system provided in a fifth embodiment of the present disclosure.

In this embodiment, as shown in FIG. 10, the system can include:

A CPU 101 and a GPU 102 connected with the CPU 101;

The GPU is configured to perform following operations for the speech recognition method:

Receiving a feature vector and a decoding map sent by a CPU, where the feature vector is extracted from a speech signal and the decoding map is pre-trained;

Recognizing the feature vector according to a pre-trained acoustic model to obtain a probability matrix;

Decoding the probability matrix according to the decoding map using a parallel mechanism to obtain text sequence information; and

Sending the text sequence information to the CPU.

In an embodiment, the recognizing the feature vector according to the pre-trained acoustic model to obtain the probability matrix includes:

Obtaining active label objects of each frame according to the decoding map and the probability matrix;

Obtaining an active label object with the lowest traversal cost of each frame;

Backtracking and obtaining a decoding path according to the active label object with the lowest traversal cost; and

Obtaining the text sequence information according to the decoding path.

In an embodiment, the obtaining active label objects of each frame according to the decoding map and the probability matrix includes:

Processing in parallel a non-transmitted state for a current frame to obtain a plurality of label objects, where the non-transmitted state is referred to as a state in which an input label of an edge, transmitted from the decoding map, is NULL, and each of the label objects correspondingly records an output label of each state after the current frame is trimmed and an accumulated traversal cost;

Calculating a cutting-off cost for the current frame using a predefined constraint parameter if the current frame is a first frame;

Comparing the traversal cost recorded by each of the label objects with the cutting-off cost, and cutting off label objects whose traversal cost exceed the cutting-off cost to obtain the active label objects of the current frame; and

Calculating a cutting-off cost of a next frame according to the active label object with the lowest traversal cost in the active label objects of the current frame and the constraint parameter if the current frame is not a last frame.

The CPU is configured to perform following operations for the speech recognition method:

Extracting a feature vector from a speech signal;

Acquiring a decoding map which is pre-trained;

Sending the feature vector and the decoding map to a GPU, to enable the GPU to recognize the feature vector according to a pre-trained acoustic model to obtain a probability matrix and decode the probability matrix according to the decoding map using a parallel mechanism to obtain text sequence information; and

Receiving the text sequence information sent by the GPU.

The present embodiment can further include a storage. The connection relationship among the CPU, the GPU, and the storage may be in two manners as follow.

In a first manner: the CPU and the GPU can be connected with the same storage, which can store programs corresponding to the methods to be executed by the CPU and the GPU.

In a second manner: the number of the storage may be two, that is, a first storage and a second storage, the CPU may be connected to the first memory. The first storage can be connected with the CPU and store a program corresponding to the method to be executed by the CPU. The second storage can be connected with the GPU and store a program corresponding to the method to be executed by the GPU.

Further, a storage medium can be provided in a sixth embodiment of the present disclosure, which stores a first computer program and a second computer program.

When the first computer program is executed by the GPU, each of following operations for the speech recognition method is implemented:

Receiving a feature vector and a decoding map sent by a CPU, where the feature vector is extracted from a speech signal and the decoding map is pre-trained;

Recognizing the feature vector according to a pre-trained acoustic model to obtain a probability matrix;

Decoding the probability matrix according to the decoding map using a parallel mechanism to obtain text sequence information; and

Sending the text sequence information to the CPU.

In an embodiment, the recognizing the feature vector according to the pre-trained acoustic model to obtain the probability matrix includes:

Obtaining active label objects of each frame according to the decoding map and the probability matrix;

Obtaining an active label object with the lowest traversal cost of each frame;

Backtracking and obtaining a decoding path according to the active label object with the lowest traversal cost; and

Obtaining the text sequence information according to the decoding path.

In an embodiment, the obtaining active label objects of each frame according to the decoding map and the probability matrix includes:

Processing in parallel a non-transmitted state for a current frame to obtain a plurality of label objects, where the non-transmitted state is referred to as a state in which an input label of an edge, transmitted from the decoding map, is NULL, and each of the label objects correspondingly records an output label of each state after the current frame is trimmed and an accumulated traversal cost;

Calculating a cutting-off cost for the current frame using a predefined constraint parameter if the current frame is a first frame;

Comparing the traversal cost recorded by each of the label objects with the cutting-off cost, and cutting off label objects whose traversal cost exceed the cutting-off cost to obtain the active label objects of the current frame; and

Calculating a cutting-off cost of a next frame according to the active label object with the lowest traversal cost in the active label objects of the current frame and the constraint parameter if the current frame is not a last frame.

When the second computer program is executed by the CPU, each of following operations for the speech recognition method is implemented:

Extracting a feature vector from a speech signal;

Acquiring a decoding map which is pre-trained;

Sending the feature vector and the decoding map to a GPU, to enable the GPU to recognize the feature vector according to a pre-trained acoustic model to obtain a probability matrix and decode the probability matrix according to the decoding map using a parallel mechanism to obtain text sequence information; and

Receiving the text sequence information sent by the GPU.

FIG. 11 is a schematic flowchart of a speech recognition method provided in a seventh embodiment of the present disclosure.

In this embodiment, a speech recognition method is described according to the interaction between the CPU and the GPU. As shown in FIG. 11, the present embodiment includes following operations:

Operation 111: extracting a feature vector from a speech signal.

Operation 112: acquiring a decoding map.

Operation 113: sending the feature vector and the decoding map to the GPU.

Operation 114: receiving the feature vector and the decoding map sent by the CPU.

Operation 115: recognizing the feature vector according to a pre-trained acoustic model to obtain a probability matrix.

Operation 116: obtaining active label objects of each frame according to the decoding map and the probability matrix.

Operation 117: processing in parallel a non-transmitted state for a current frame to obtain a plurality of label objects.

Operation 118: calculating a cutting-off cost for the current frame using a predefined constraint parameter if the current frame is a first frame.

Operation 119: comparing the traversal cost recorded by each of the label objects with the cutting-off cost, and cutting off label objects whose traversal cost exceed the cutting-off cost to obtain the active label objects of the current frame.

Operation 1110: calculating a cutting-off cost of a next frame according to the active label object with the lowest traversal cost in the active label objects of the current frame and the constraint parameter if the current frame is not a last frame.

Operation 1111: backtracking and obtaining a decoding path according to the active label object with the lowest traversal cost.

Operation 1112: obtaining the text sequence information according to the decoding path.

Operation 1113: sending the text sequence information to the CPU.

Operation 1114: receiving the text sequence information sent by the GPU.

It will be apparent that the same or similar portions in the above embodiments can be referred to each other, and the contents not described in detail in some embodiments can be referred to the same or similar contents in other embodiments.

It should be noted that, in the specification of the present disclosure, the terms “first”, “second” and the like are used for descriptive purposes only and should be interpreted to indicate or imply relative importance. Further, in the specification of the present disclosure, unless otherwise stated, the term “plurality of” means at least two.

Any process or method described in the flowchart or otherwise described herein can be understood as one or more modules of, fragments of, or parts of executable instruction code for implementing the operation of a particular logical function or process. The scope of the preferred embodiment of the present disclosure includes further implementations in which functions may not be performed in the order shown or discussed, including in a substantially simultaneous manner or in a reverse order according to the functions involved, which all should be understood by those skilled in the art.

It will be apparent that various parts of the present disclosure can be implemented by a hardware, a software, a firmware, or a combination thereof. In the above embodiments, a plurality of operations or methods can be implemented by the software or the firmware stored in storage and executed by a suitable instruction execution system. For example, in the case that the various parts of the present disclosure implemented by the hardware, as in other embodiments, they can be implemented by any or a combination of the following techniques known in the art: a discrete logic circuit having logic gates for performing logic function on data signal, an application specific integrated circuit having a suitable combined logic gate circuit, a programmable gate array (PGA), a field programmable gate array (FPGA), and the like.

Those skilled in the art will appreciate that all or a portion of the operations involved in the methods of above embodiments can be implemented by a manner that a program instructs a relevant hardware. The program can be stored in a computer-readable storage medium, and can include one of or a combination of the operations of the methods when executed.

In addition, each functional unit in various embodiments of the present disclosure can be integrated in one processing module, or can physically and separately exist, or two or more units can be integrated in one module. The integrated module can either be implemented in a hardware form or in a software functional module form. In the case that the integrated module is implemented as the software functional module form and sold or used as a stand-alone product, the integrated module can also be stored in a computer-readable storage medium.

The above-mentioned storage medium can be a read-only memory, a magnetic disk, an optical disk, or the like.

In the description of this specification, the terms “an embodiment”, “some embodiments”, “a specific example”, “some examples” means that specific features, structures, materials or characteristics incorporated in certain embodiments or in examples can be included in at least one embodiment of the present disclosure. In this specification, the schematic representations for the above terms do not necessarily refer to the same embodiment or same example. Moreover, the specific features, the structures, the materials or the characteristics can be combined in a suitable manner in any one or more embodiments or examples.

Although embodiments of the present disclosure have been shown and described above, it will be understood that the above embodiments are exemplary and cannot be construed as limiting the present disclosure, and that those of ordinary skill in the art may make variations, modifications, replacements and variations to the above embodiments within the scope of the present disclosure.

What is claimed is:

1. A speech recognition method, comprising:
receiving a feature vector and a decoding map sent by a central processing unit (CPU), wherein the feature vector is extracted from a speech signal, and the decoding map is pre-trained;
recognizing the feature vector according to a pre-trained acoustic model to obtain a probability matrix;
decoding the probability matrix according to the decoding map using a parallel mechanism to obtain text sequence information; and
sending the text sequence information to the CPU.

2. The method according to claim 1, wherein the decoding the probability matrix according to the decoding map using the parallel mechanism to obtain the text sequence information comprises:
obtaining active label objects of each frame according to the decoding map and the probability matrix;
obtaining an active label object with the lowest traversal cost of each frame;
backtracking and obtaining a decoding path according to the active label object with the lowest traversal cost; and
obtaining the text sequence information according to the decoding path.

3. The method according to claim 2, wherein the obtaining the active label objects of each frame according to the decoding map and the probability matrix comprises:
processing in parallel a non-transmitted state for a current frame to obtain a plurality of label objects, wherein the non-transmitted state is referred to as a state in which an input label of an edge, transmitted from the decoding map, is NULL, and each of the label objects correspondingly records an output label of each state after the current frame is trimmed and an accumulated traversal cost;
calculating a cutting-off cost for the current frame using a predefined constraint parameter if the current frame is a first frame;
comparing the traversal cost recorded by each of the label objects with the cutting-off cost, and cutting off label objects whose traversal cost exceed the cutting-off cost to obtain the active label objects of the current frame; and
calculating a cutting-off cost of a next frame according to the active label object with the lowest traversal cost in the active label objects of the current frame and the constraint parameter if the current frame is not a last frame.

4. A speech recognition method, comprising:
extracting a feature vector from a speech signal;
acquiring a decoding map which is pre-trained;
sending the feature vector and the decoding map to a graphics processing unit (GPU), to enable the GPU to recognize the feature vector according to a pre-trained acoustic model to obtain a probability matrix and decode the probability matrix according to the decoding map using a parallel mechanism to obtain text sequence information; and
receiving the text sequence information sent by the GPU.

5-7. (canceled)

8. A storage medium, which stores a first computer program and a second computer program, wherein
when the first computer program is executed by a GPU, following operations are implemented:
receiving a feature vector and a decoding map sent by a CPU;
recognizing the feature vector according to a pre-trained acoustic model to obtain a probability matrix;
decoding the probability matrix according to the decoding map using a parallel mechanism to obtain text sequence information; and
sending the text sequence information to the CPU; and
when the second computer program is executed by the CPU, following operations are implemented:
extracting the feature vector from a speech signal;
acquiring the decoding map which is pre-trained;
sending the feature vector and the decoding map to the GPU; and
receiving text sequence information sent by the GPU.

9. The storage medium according to claim 8, wherein when the first computer program is executed by the GPU, the decoding the probability matrix according to the decoding map using the parallel mechanism to obtain the text sequence information comprises:
obtaining active label objects of each frame according to the decoding map and the probability matrix;
obtaining an active label object with the lowest traversal cost of each frame;
backtracking and obtaining a decoding path according to the active label object with the lowest traversal cost; and
obtaining the text sequence information according to the decoding path.

10. The storage medium according to claim 9, wherein when the first computer program is executed by the GPU, the obtaining the active label objects of each frame according to the decoding map and the probability matrix comprises:
processing in parallel a non-transmitted state for a current frame to obtain a plurality of label objects, wherein the non-transmitted state is referred to as a state in which an input label of an edge, transmitted from the decoding map, is NULL, and each of the label objects correspondingly records an output label of each state after the current frame is trimmed and an accumulated traversal cost;
calculating a cutting-off cost for the current frame using a predefined constraint parameter if the current frame is a first frame;
comparing the traversal cost recorded by each of the label objects with the cutting-off cost, and cutting off label objects whose traversal cost exceed the cutting-off cost to obtain the active label objects of the current frame; and
calculating a cutting-off cost of a next frame according to the active label object with the lowest traversal cost in the active label objects of the current frame and the constraint parameter if the current frame is not a last frame.
